(19) United States
(12) Patent Application Publication
(10) Pub. No.: US 2024/0292196 A1
(43) Pub. Date: Aug. 29, 2024

(54) METAVERSE SERVICE ORCHESTRATION IN WIRELESS COMMUNICATION NETWORKS

(71) Applicant: T-MOBILE INNOVATIONS LLC, Overland Park, KS (US)

(72) Inventors: Marouane Balmakhtar, Fairfax, VA (US); Zhisheng Chen, Overland Park, KS (US)

(21) Appl. No.: 18/175,213

(22) Filed: Feb. 27, 2023

(51) Int. Cl. H04W 4/50; H04W 4/02; H04W 48/18

(52) U.S. Cl. CPC H04W 4/50; H04W 4/023; H04W 48/18

(57) ABSTRACT

Various embodiments comprise a wireless communication network configured to orchestrate metaverse services for wireless user devices. The wireless communication network comprises a metaverse orchestrator and a network slice manager. The metaverse orchestrator receives and processes a metaverse service request from a wireless user device that indicates a device location and a metaverse type. The metaverse orchestrator identifies application servers that provide metaverse services and that have sufficient capacity to serve a metaverse session. The metaverse orchestrator selects a server of the identified ones of the identified application servers based on a proximity between the device location and the geographic location of the server. The network slice manager selects a network slice to serve the metaverse session based on the metaverse type indicated by the metaverse service request.

### BACKGROUND

Metaverse applications provide simulated experiences. The simulated experiences comprise pose tracking for the user and Three-Dimension (3D) near-eye displays to provide the user an immersive feel of a virtual environment. The metaverse applications may be used for voice/video conferencing, social media, online gaming, peer-to-peer communications, and the like. Exemplary metaverse applications and services include metaverse spaces and communication applications including real-time 2D/3D video, digital avatars presence, digital twin, High Definition (HD) voice, data exchange from distributed storage servers, interactive near-real-time controls/actions (as in gaming), theme/space exhibition/simulation, and the like. The metaverse applications are hosted by application servers. User devices communicate with the metaverse servers over communication networks like wireless communication networks and the internet to receive the metaverse services provided by the applications. Some metaverse applications utilize large amounts of distributed computing. It is difficult to support metaverse services using separate network and computing services. This difficulty is compounded as metaverse application server orchestration is separate from wireless network orchestration.

The metaverse applications often comprise significant latency and bandwidth requirements. The traffic profile for metaverse applications also varies from between different types of metaverse applications. For example, metaverse applications that provide virtual reality services consume significant bandwidth and are sensitive to latency metrics. In contrast, metaverse applications that provide augmented reality services require significant computation, data collaboration, and high latency but lower bandwidth. Other metaverse applications that support virtual theme parks, virtual gaming, and virtual shopping may require significant data pre-downloads. The data traffic for a given metaverse application may comprise ultra-low latency in the range of 0-5 ms. When the latency, bandwidth, and/or traffic profile requirements are not met, the user may experience jittering, lag, or other glitches that reduce the immersive feel of the virtual environment which degrades the overall user experience. For example, users in metaverse environments often experience dizziness or nausea when latency exceeds 15 ms. Unfortunately, wireless communication networks do not efficiently support user sessions for metaverse applications. Moreover, the wireless communication networks do not effectively utilize network slicing to support metaverse applications and manage application server capacity.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions providing metaverse services to wireless user devices. Some embodiments comprise a method of operating a wireless communication network to orchestrate metaverse services for wireless user devices. The method comprises receiving and processing a metaverse service request from a wireless user device that indicates a device location and a metaverse type. The method further comprises selecting a network slice to serve a metaverse session based on the metaverse type indicated by the metaverse service request. The method further comprises identifying application servers that provide metaverse services that have sufficient capacity to serve the metaverse session. The method further comprises selecting a server of the identified application servers based on a proximity between the device location and a geographic location of the server.

Some embodiments comprise a wireless communication network configured to orchestrate metaverse services for wireless user devices. The wireless communication network comprises a metaverse orchestrator and a network slice manager. The metaverse orchestrator receives and processes a metaverse service request from a wireless user device that indicates a device location and a metaverse type. The metaverse orchestrator identifies application servers that provide metaverse services and that have sufficient capacity to serve a metaverse session. The metaverse orchestrator selects a server of the identified ones of the identified application servers based on a proximity between the device location and the geographic location of the server. The network slice manager selects a network slice to serve the metaverse session based on the metaverse type indicated by the metaverse service request.

Some embodiments comprise a method of operating a wireless communication network to orchestrate metaverse services for wireless user devices. The method comprises monitoring geographic locations and capacities for metaverse application servers. The method further comprises receiving and processing a metaverse service request from a wireless user device that indicates a device location and a metaverse type. The method further comprises selecting a network slice to serve a metaverse session based on the metaverse type indicated by the metaverse service request. The method further comprises identifying ones of the application servers that comprise the capacity to serve the metaverse session. The method further comprises selecting one of the identified metaverse application servers based on a proximity between the device location and a server geographic location. The method further comprises directing the selected metaverse application server to deploy a metaverse application for the metaverse session. The method further comprises exchanging user data for the metaverse session with the wireless user device over the network slice. The method further comprises exchanging the user data for the metaverse session with the selected metaverse application server.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a wireless communication network to orchestrate metaverse services for a wireless user device.

FIG. 2 illustrates an exemplary operation of the wireless communication network to orchestrate metaverse services for a wireless user device.

FIG. 3 illustrates a wireless communication network to orchestrate metaverse services for a wireless user device.

FIG. 4 illustrates an exemplary operation of the wireless communication network to orchestrate metaverse services for a wireless user device.

FIG. 5 illustrates another exemplary operation of the wireless communication network to orchestrate metaverse services for a wireless user device.

FIG. 6 illustrates a Fifth Generation (5G) communication network to orchestrate metaverse services for a wireless user device.

FIG. 7 illustrates a Third Generation Partnership Project 5G User Equipment (UE) in the 5G communication network.

FIG. 8 illustrates a 5G Radio Access Network (RAN) in the 5G communication network.

FIG. 9 illustrates a Network Function Virtualization Infrastructure (NFVI) in the 5G communication network.

FIG. 10 further illustrates the NFVI in the 5G communication networks.

FIG. 11 illustrates an exemplary operation of the 5G communication network to orchestrate metaverse services for a wireless user device.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

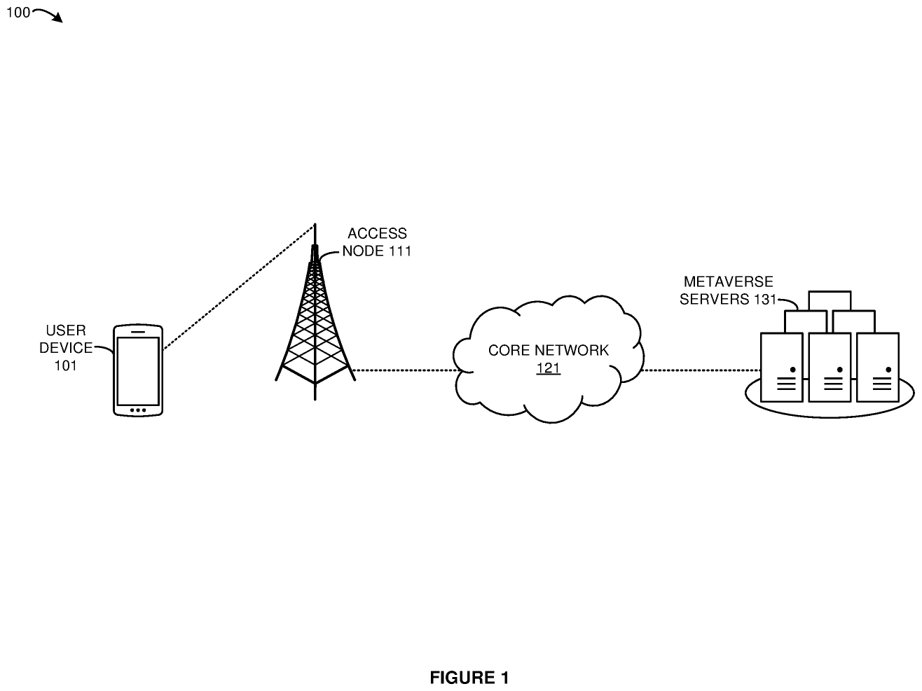

FIG. 1 illustrates wireless communication network 100 network to orchestrate metaverse services for wireless user devices. Wireless communication network 100 delivers services like machine communications, internet-access, media-streaming, or some other wireless communications product. Wireless communication network 100 comprises user device 101, access node 111, core network 121, and metaverse servers 131.

Various examples of network operation and configuration are described herein. In some examples, core network 121 monitors the geographic location and capacity for metaverse servers 131. Metaverse servers 131 may transfer status reports to core network 121 indicating location and capacity for each of the servers 131. The geographic location and capacity data in the status reports may comprise information like bandwidth, routing path, computing location, data sources, Central Processing Unit (CPU) load, Graphical Processing Unit (GPU) load, Random Access Memory (RAM) percent occupancy, disc storage percent occupancy, and the like. Core network 121 may maintain a data structure to track the location and capacity of servers 131. Core network 121 receives and processes a metaverse service request from wireless user device 101. The metaverse service request indicates a device location for user device 101 and a metaverse type. Examples of metaverse types include virtual reality applications, augmented reality applications, and metaverse applications for voice/video conferencing, gaming, media streaming, peer-to-peer communications, and the like that are provided by metaverse servers 131. For example, one of metaverse servers 131 may host a metaverse application for voice/video conferencing while another one of metaverse servers 131 may host a metaverse application for virtual reality online gaming. Core network 121 selects a network slice to serve a metaverse session based on the metaverse type indicated by the metaverse service request. Network slices typically comprise groups of network functions like Access and Mobility Management Function (AMF), Session Management Function (SMF), User Plane Function (UPF), and/or other network functions configured to support wireless network services for a wireless user device. Core network 121 identifies ones of the metaverse servers 131 that comprises the capacity to serve the metaverse session. For example, core network 121 may determine hardware and software capacity for each of servers 131 and identify ones of servers 131 that comprise hardware and/or software capacity above a threshold value. Core network 121 a server of the identified ones of metaverse servers 131 based on a proximity between the device location of user device 101 and a server geographic location for the selected one of servers 131.

Wireless communication network 100 provides wireless data services to wireless user devices like user device 101. Exemplary wireless data services include machine-control, internet-access, media-streaming, and social-networking. Exemplary wireless user devices comprise phones, computers, vehicles, robots, and sensors. Access node 111 comprises an example of a Radio Access Network (RAN). RANs exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores like core network 121. The RANs are connected to the wireless network cores over backhaul data links. Access node 111 and core network 121 may communicate via edge networks like internet backbone providers, edge computing systems, or another type of edge system to provide the backhaul data links between node 111 and core network 121.

The RANs (e.g., access node 111) comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUS which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in the network cores (e.g., core network 121). The network cores execute the network functions to provide wireless data services to the wireless user devices over the RANs. Exemplary network functions include AMF, SMF, UPF, Network Slice Selection Function (NSSF), Communication Service Management Function (CSMF), Network Slice Subnet Management Function (NSSMF), and Metaverse Client Server Controller (MCSC). Metaverse servers 131 comprise an example of application servers that host metaverse applications like metaverse spaces, virtual reality applications, and augmented reality applications. Metaverse servers 131 interface with core network 121 over communication links like public internet links.

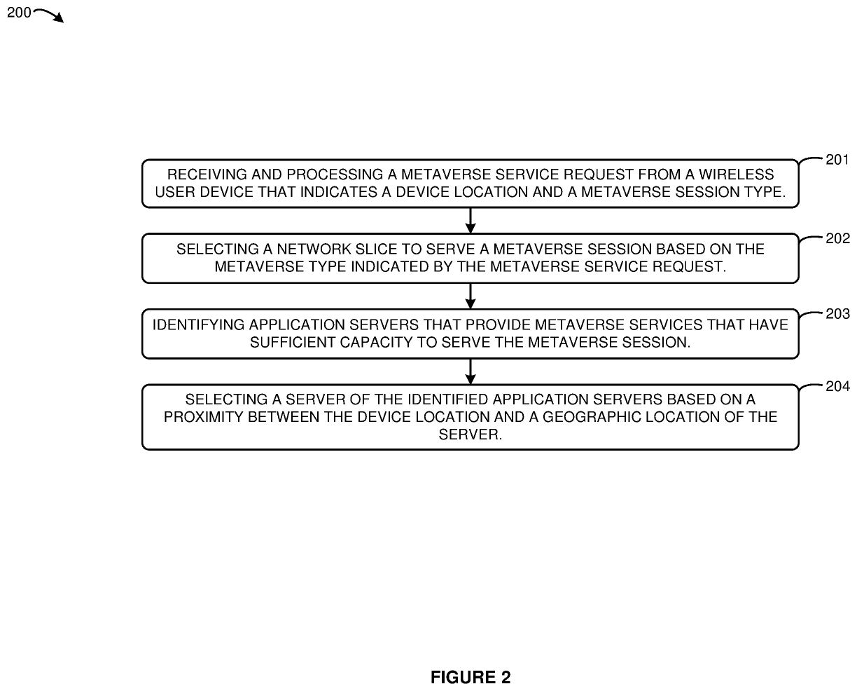

FIG. 2 illustrates process 200. Process 200 comprises an exemplary operation of wireless communication network 100 to orchestrate metaverse services for wireless user device 101. The operation may vary in other examples. The operations of process 200 comprise receiving and processing a metaverse service request from a wireless user device that indicates a device location and a metaverse type (step 201). The operations further comprises selecting a network slice to serve a metaverse session based on the metaverse type indicated by the metaverse service request (step 202). The operations further comprise identifying application servers that provide metaverse services that have sufficient capacity to serve the metaverse session (step 203). The operations further comprise selecting a server of the identified application servers based on a proximity between the device location and a geographic location of the server (step 204).

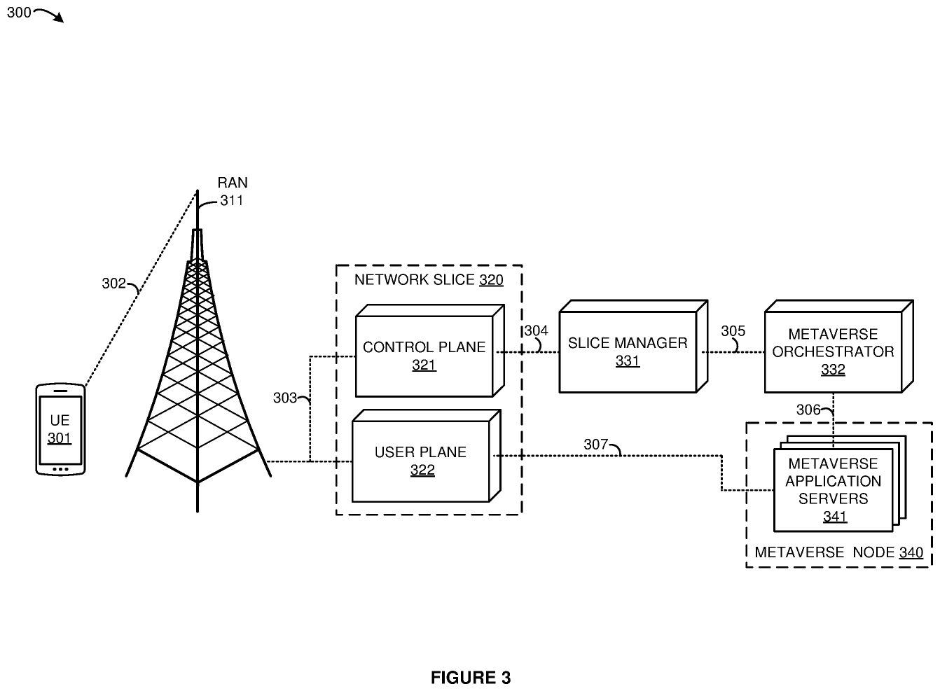

FIG. 3 illustrates wireless communication network 300 network to orchestrate metaverse services for wireless user devices. Wireless communication network 300 is an example of communication network 100, however network 100 may differ. Wireless communication network 300 comprises User Equipment (UE) 301, links 302-307, RAN 311, network slice 320, slice manager 331, metaverse orchestrator 332, and metaverse node 340. Network slice 320 comprises control plane 321 and user plane 322. Metaverse node 340 comprise metaverse application servers 341. In other examples, wireless network communication network 300 may comprise additional or different elements than those illustrated in FIG. 3.

In some examples, metaverse orchestrator 332 monitors the capacity and geographic location of metaverse application servers 341 in metaverse node 340. Metaverse orchestrator 332 receives and processes a metaverse service request that indicates a device location and a metaverse type. For example, UE 301 may attach to RAN 311 and transfer a service request for delivery to control plane 321. The service request may indicate a request for a metaverse space to participate in a peer-to-peer virtual reality video conference and the geographic location of UE 301. Control plane 321 may detect the metaverse request and forward the service request to orchestrator 332. Orchestrator 332 interfaces with slice manager 331 to select a network slice to serve a metaverse session for UE 301 based on the requested metaverse type. Slice manager 331 selects network slice 320 comprising control plane 321 and user plane 322 to support the metaverse session for UE 301. For example, the metaverse session may comprise an Ultra-Reliable Low-Latency Communication (uRLLC) session and slice manager 331 may select a network slice comprising an uRLLC capable control plane and a uRLLC capable user plane to support the requested metaverse session. Orchestrator 332 identifies ones of application servers 341 that comprise the capacity to serve the metaverse session. Of the identified servers, orchestrator 332 selects one of servers 341 to serve the metaverse session based on its proximity to UE 301. For example, orchestrator 332 may determine geographic distances between UE 301 and the identified ones of servers 341 and select a server that comprises a minimum distance. Metaverse sessions often comprise strict latency requirements and minimizing geographic distance between the hosting server and UE 301 reduces latency. Orchestrator 341 directs the selected one of application servers 341 to serve to metaverse session for UE 301. User plane 322 in network slice 320 exchanges user data for the metaverse session with UE 301 over RAN 311. User plane 322 exchanges the user data with the selected one of metaverse application servers 341.

Advantageously, wireless communication network 300 efficiently orchestrates metaverse servers to support user sessions for metaverse applications. Moreover, wireless communication network 300 effectively utilizes network slicing to support metaverse applications and manage application server capacity. The network slicing employed by network 300 ensures that adequate network computing, storage, and communication resources are properly allocated to the requested metaverse sessions. As such, this resource allocation ensures high availability, satisfactory performance levels, and maintains other Service Level Agreements (SLA) criteria for the metaverse sessions.

UE 301 and RAN 311 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 311, control plane 321, user plane 322, slice manager 331, metaverse orchestrator 332, and metaverse application servers 341 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 comprises a vehicle, drone, robot, computer, phone, sensor, or another type of data appliance with wireless and/or wireline communication circuitry. Although RAN 311 is illustrated as a tower, RAN 311 may comprise another type of mounting structure (e.g., a building), or no mounting structure at all. RAN 311 comprises a Fifth Generation (5G) RAN, LTE RAN, gNodeB, eNodeB, NB-IoT access node, LP-WAN base station, wireless relay, WIFI hotspot, Bluetooth access nodes, and/or another wireless or wireline network transceiver. UE 301 and RAN 311 comprise antennas, amplifiers, filters, modulation, analog/digital interfaces, microprocessors, software, memories, transceivers, bus circuitry, and the like. Control plane 321 comprises network functions like AMF, SMF, and the like. User plane 322 comprises network functions like UPF and the like. Slice Manager 331 comprises network functions like NSSF, CSMF, Network Slice Management Function (NSMF), NSSMF, and the like. Metaverse orchestrator 332 comprise network elements like MCSC. Metaverse application servers 341 host applications like virtual reality applications, augmented reality applications, xR applications, and metaverse applications for voice/video conferencing, gaming, media streaming, and the like. Some metaverse applications hosted by servers 341 do not require a distributed structure as their latency requirements are low. In the examples where servers 341 are distributed, servers 341 could be hosted by a network provider and/or a stand-alone by 3rd party. When hosted by a network provider, one or more of servers 341 may be integrated into an edge node like an edge UPF. In the case of a stand-alone by 3rd party hosting, one or more of servers 341 may comprise i-UPFs inserted at edge nodes. Wireless communication network 300 may comprise additional functions like Authentication Server Function (AUSF), Policy Control Function (PCF), and Unified Data Managements (UDM). UE 301, RAN 311, control plane 321, user plane 322, slice manager 331, metaverse orchestrator 332, and metaverse application servers 341 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 300 as described herein.

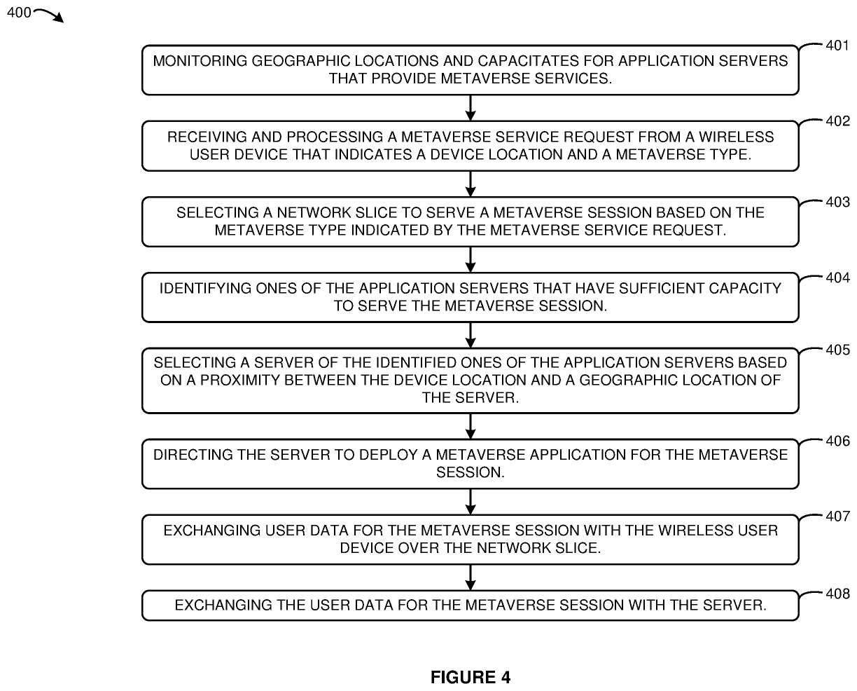

FIG. 4 illustrates process 400. Process 400 comprises an exemplary operation of wireless communication network 300 to orchestrate metaverse services for UE 301. The operation may vary in other examples. The operations of process 400 comprise monitoring geographic locations and capacities for application servers that provide metaverse services (step 401). The operations further comprise receiving and processing a metaverse service request from a wireless user device that indicates a device location and a metaverse type (step 402). The operations further comprise selecting a network slice to serve a metaverse session based on the metaverse type indicated by the metaverse service request (step 403). The operations further comprise identifying ones of the application servers that have sufficient capacity to serve the metaverse session (step 404). The operations further comprise selecting a server of the identified ones of the application servers based on a proximity between the device location and a geographic location of the server (step 405). The operations further comprise directing the server to deploy a metaverse application for the metaverse session (step 406). The operations further comprise exchanging user data for the metaverse session with the wireless user device over the network slice (step 407). The operations further comprise exchanging the user data for the metaverse session with the server (step 408).

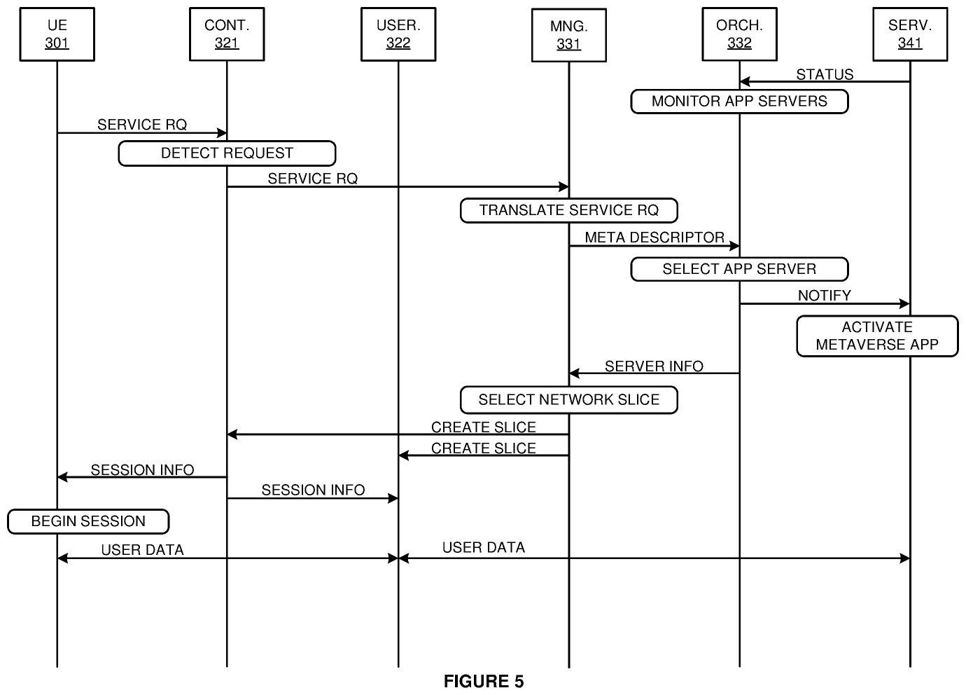

FIG. 5 illustrates an exemplary operation of wireless communication network 300 to orchestrate metaverse services for UE 301. The operation may vary in other examples. In operation, metaverse application servers (SERV.) 341 transfer status reports to metaverse orchestrator (ORCH.) 332. Each status report indicates the hardware capacity, software capacity, and geographic location for the application server that generated and transferred the status report. Orchestrator 332 monitors metaverse servers 341 based on the status reports. For example, orchestrator 332 may maintain a data structure that lists each of application servers 341 in association with their geographic location, software capacity, and hardware capacity. In some examples, the status reports may include additional information like server capabilities, active metaverse application types, active/inactive status, and/or other types of information characterizing the operations of metaverse application servers 341.

UE 301 attaches to RAN 311 and wirelessly transfers a service request for delivery to control plane (CONT.) 321. Control plane 321 and detects the service request comprises a request for metaverse services and responsively forwards the request to slice manager (MNG.) 331. Slice manager 331 translates the metaverse service request to a metaverse descriptor for orchestrator 332. For example, slice manager 331 may translate a slice descriptor to support the requested metaverse service into an application descriptor to implement the requested metaverse service type. Slice manager 331 transfers the metaverse descriptor to orchestrator 332. The metaverse descriptor indicates the geographic location of UE 301 and the requested metaverse service type. Orchestrator 332 determines ones of application servers 341 that comprise the hardware and/or software to support the requested service. Orchestrator 332 selects one of application servers 341 that comprise the capacity to support the service with the lowest geographic proximity to UE 301. Orchestrator 332 transfers a notification to the selected application server to spin up the metaverse application that corresponds to the requested service. For example, the request metaverse service may comprise a metaverse voice/video conferencing service and orchestrator 332 may direct the selected application server to activate a metaverse voice/video conferencing space.

Orchestrator 332 transfers server information (e.g., server address) to slice manager 331. Slice manager 331 selects network slice 320 to support the metaverse session for UE 301. For example, the metaverse session may require Enhanced Mobile BroadBand (emBB) capability and slice manager may select an emBB network slice to support the session. In some examples, an appropriate network slice may not currently exist at the time of the request and slice manager 331 may instantiate a new network slice to support the session. Slice manager 331 directs control plane 321 and user plane (USER.) 322 to form network slice 320. Slice manager 331 indicates session information like application server network addresses to control plane 321. Control plane 321 transfers the session information to UE 301 and user plane 322 and directs UE 301 to begin the metaverse session. UE 301 exchanges user data for the metaverse session with user plane 322 over RAN 311. User plane 322 exchanges the user data with the selected one of metaverse application servers 341.

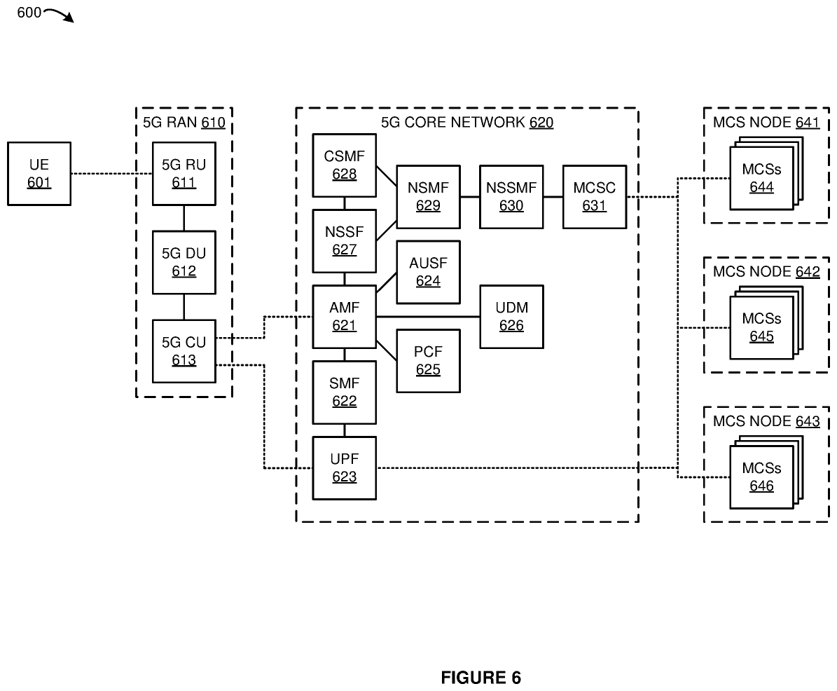

FIG. 6 illustrates 5G communication network 600 to orchestrate metaverse services for UE 601. 5G communication network 600 comprises an example of wireless communication networks 100 and 300, although networks 100 and 300 may differ. 5G communication network 600 comprises UE 601, 5G RAN 610, 5G network core 620, and Meta Verse Client Server (MCS) nodes 641-643. 5G RAN 610 comprises 5G RU 611, 5G DU 612, and 5G CU 613. Core network 620 comprises AMF 621, SMF 622, UPF 623, AUSF 624, PCF 625, UDM 626, NSSF 627, CSMF 628, NSMF 629, NSSMF 630, and MCSC 631. MCS nodes 641-643 comprise MCSs 644-646 respectively. One or more of MCS nodes 641-643 may comprise edge computing systems such as co-located edge UPFs that provide local edge computing services for MCSs 644-646 in nodes 641-643. Other network functions and network elements like Network Exposure Function (NEF) are typically present in and 5G network core 620 but are omitted for clarity.

MCSs 644-646 host metaverse applications to provide metaverse services for user devices like virtual voice/video conferencing, virtual spaces, online gaming, peer-to-peer communication, and/or other types of metaverse services. MCSs 644-646 track their hardware usage, hardware capacity, software usage, software capacity, and geographic locations. The capacity and usage statistics tracked by MCSs 644-646 may comprise memory percent occupancy, processor load, number of active metaverse applications, number of active users, application usage, number of additional applications that can be hosted, number of additional users that can be served, server Global Positioning System (GPS) coordinates, and/or other types of Key Performance Indicators (KPIs) characterizing hardware/software usage and capacity. MCSs 644-646 generate and transfer status reports that include their hardware usage, hardware capacity, software usage, software capacity, and geographic locations to MCSC 631. MCSs 644-646 may generate and transfer their status reports periodically, randomly, continually, or over some other time scale. In some examples, MCSs 644-646 may comprise and/or utilize edge computing infrastructure. MCSs 644-646 may be co-located with edge UPFs and/or i-UPFs provided by 3^{rd} party providers or customers.

MCSC 631 maintains a data structure to track the hardware usage, hardware capacity, software usage, software capacity, and geographic locations for MCSs 644-646. MCSC 631 stores the hardware usage, hardware capacity, software usage, software capacity, and geographic locations in association with server ID and server network address. MCSC 631 updates the hardware usage, hardware capacity, software usage, software capacity, and geographic locations for MCSs 644-646 upon receiving subsequent status reports. When software usage falls below a threshold value for a metaverse application hosted by one of MCSs 644-646, MCSC 631 directs the hosting one of MCSs 644-646 to deactivate the underused application to free up hardware capacity. MCSC 631 assists the hosting one of MCSs 644-646 to redirect users that were served by the deactivated application to another suitable metaverse application to efficiently allocate and conserve computing resources. Likewise, when software usage exceeds a threshold value for a metaverse application hosted by one of MCSs 644-646, MCSC 631 identifies one of MCSs 644-646 with adequate hardware capacity and directs the identified one of MCSs 644-646 to activate an additional metaverse application to provide metaverse services to additional users. MCSC 631 load balances metaverse service requests for MCSs 644-646 based on the capacity and geographic locations indicated by the data structure. In doing so, MCSC 631 inhibits MCS overload. For example, if an MCS in MCSs 644 has limited available computing resources, MCSC 631 may assign incoming service requests to another MCS in MCSs 644 with a greater amount of available computing resources. It should be appreciated that due to the latency requirements in some metaverse applications, MCSC 631 may be geographically restricted in its load balancing operations. For example, MCSC 631 may load balance service requests between ones of MCSs 644-646 that can support the latency of requirements of the requested metaverse service. In contrast to traditional load balancing techniques, this may lead to situations where MCSC 631 selects a more heavily loaded MCS instead of a less heavily loaded MCS if the less loaded MCS cannot support the latency requirements or other SLA requirements (e.g., bandwidth) of the requested metaverse session.

UE 601 wirelessly attaches to CU 613 via DU 612 and RU 611. UE 601 exchanges attachment signaling with CU 613 to establish a Radio Resource Control (RRC) connection with 5G network applications hosted by CU 613. The attachment signaling indicates information like a registration type, UE capabilities, requested slice types, and PDU session requests. CU 613 transfers a registration request for UE 601 to AMF 621. The registration request comprises information transferred by UE 601 in the attachment signaling. AMF 621 transfers an identify request to UE 601 via RAN 610 and UE 601 responsively indicates its identity to AMF 621 via RAN 610. AMF 621 interacts with AUSF 624, UDM 626, and typically other network functions to authenticate and authorize UE 601 for wireless data services. For example, AMF 621 may generate and transfer an authentication challenge to UE 601 using cryptography information received from AUSF 624 and UDM 625.

Responsive to the authentication and authorization, AMF 621 requests UE context for UE 601 from UDM 626. UDM 626 transfers UE context for UE 601 to AMF 621. The UE context comprises Quality-of-Service (QOS) metrics, slice identifiers, network addresses, and the like. AMF 621 retrieves service policies for UE 601 from PCF 625. AMF 621 selects SMF 622 to establish a Protocol Data Unit (PDU) session for UE 601 based on the UE context and the service policies. SMF 622 selects UPF 623 to establish the PDU session for UE 601. SMF 622 transfers session context for the PDU session to AMF 621. AMF 621 transfers the session context to UE 601 over RAN 610. UE 601 begins the PDU session based on the session context. UE 601 wirelessly exchanges user data with CU 613 over RU 611 and DU 612. CU 613 exchanges the user data with UPF 623.

UE 601 executes a metaverse application. For example, UE 601 may receive a user input via its user interface systems launching a metaverse voice/video conferencing application. In response to the application execution, UE 601 transfers a corresponding service request to AMF 621 via RAN 610. AMF 621 detects the metaverse service request and indicates the request to CSMF 628 to select, or instantiate if one is unavailable, an adequate network slice to handle the metaverse session. CSMF 628 receives the indication and transfers a network slice request to NSSF 627. NSSF 627 generates a network slice template based on the request and transfers the template to NSSMF 630. For example, CSMF 628 may determine the metaverse request comprises a request for a metaverse voice/video conferencing application and transfers a slice request for a network slice to support the metaverse voice/video conferencing session to NSSF 627. For example, the metaverse voice/video conferencing session may comprise bandwidth requirements and NSSF 627 may generate a network slice template for an emBB slice based on the session bandwidth requirements.

NSSMF 630 receives the network slice template and generates a metaverse service descriptor based on the template. The metaverse service descriptor comprise metaverse application requirements to support the requested metaverse session including information like application type, traffic type, latency requirements, bandwidth requirements, geographic location, and/or other types of service descriptors. NSSMF 630 transfers the metaverse service descriptor to MCSC 631. MCSC 631 identifies ones of MCSs 644-646 that comprise software and/or hardware capacity to deploy an application that corresponds to the metaverse service descriptor. MCSC 631 selects one of the identified servers to deploy the metaverse service descriptor based on its proximity to UE 601 to support the latency requirements of metaverse service descriptor. For example, the latency requirement for the metaverse service descriptor may be low (e.g., 5-10 ms) and MCSC 631 may select an MCS with a minimum geographic proximity to UE 601. Alternatively, the latency requirement for the metaverse service descriptor may be semi-medium (e.g., 10 ms-50 ms) and MCSC 631 may select an MCS with adequate geographic proximity to UE 601. It should be appreciated that as the required latency decreases, the importance of geographic proximity increases.

Upon selection of an MCS, MCSC 631 directs the selected MCS to deploy the metaverse application that corresponds to the descriptor. MCSC 631 relays server information (e.g., node ID and network address) for the selected MCS to NSMF 629 and NSSF 627. MCSC 631 maintains a list of network slice types to support various metaverse service descriptors. MCSC 631 informs NSSF 627 of the required slice type (e.g., uRLLC slice) to support the metaverse session. NSSF 627 selects a corresponding network slice to support the metaverse session. In this example, the selected network slice comprises AMF 621, SMF 622, UPF 623, and the deployed metaverse application. For example, in the case the selected network slice comprises a uRLLC slice, AMF 621 may comprise a common AMF, SMF 622 may comprise a uRLLC SMF, and UPF 623 may comprise a uRLLC UPF. For example, in the case the selected network slice comprises an emBB slice, AMF 621 may comprise a common AMF, SMF 622 may comprise an emBB SMF, and UPF 623 may comprise an emBB UPF. For example, in the case the selected network slice comprises a Massive Machine-Type Communications (mMTC), AMF 621 may comprise a common AMF, SMF 622 may comprise an mMTC SMF, and UPF 623 may comprise an mMTC UPF. It should be appreciated that the selected slice type depends in part on the metaverse session type and that other slice types are suitable. In some examples, the network slice type requested by MCSC 631 may be at capacity. In such cases, NSSF 627 notifies MCSC 631 that the requested network slice type is at capacity. In response, MCSC 631 generates and transfers a resources request to a network orchestration system to instantiate additional network functions to increase slice capacity. In some examples where the selected MCS may require edge computing support, MCSC 631 may generate and transfer a Local Breakout (LBO) request for edge computing support for delivery to AMF 621 or an edge computing controller (not illustrated). AMF 621 may receive and approve the LBO request and direct the associated edge systems (e.g., a co-located edge UPF) to provide edge computing services for the selected MCS. For example, metaverse applications for augmented reality or interactive 3D avatars may utilize/require edge computing support.

In response to the network slice selection, NSMF 629 controls NSSMF 630 to organize the slice subnets to exchange metaverse data between UE 601 and the deployed metaverse application. NSSMF 630 interacts with AMF 621 to isolate and forward metaverse traffic to various network destinations. NSSMF 630 stiches together the network slice subnets to build the end-to-end metaverse slice selected by NSSF 627. NSSMF 630 transfers session context information (e.g., server network address) for the metaverse session to AMF 621. AMF 621 directs SMF 622 to support the metaverse session and transfers session context to SMF 622. SMF 622 receives the direction and controls UPF 623 to serve the metaverse session. UPF 623 exchanges user data for the metaverse session with UE 601 via RAN 610. UPF 623 exchanges the user data for the session with the metaverse application deployed in the selected one of MCSs 644-646.

In some examples, multiple UEs (including UE 601) may transfer service requests for a shared metaverse session. The service requests are relayed to MCSC 631 as described above. MCSC 631 determines the service requests are for a shared metaverse session and deploys a metaverse application to one of MCSs 644-646. MCSC 631 notifies NSSF 627 and NSMF 629 to allocate each of the UEs to the same network slice. In response, NSSF 627 and NSMF 629 select and build the network slice for the shared metaverse session.

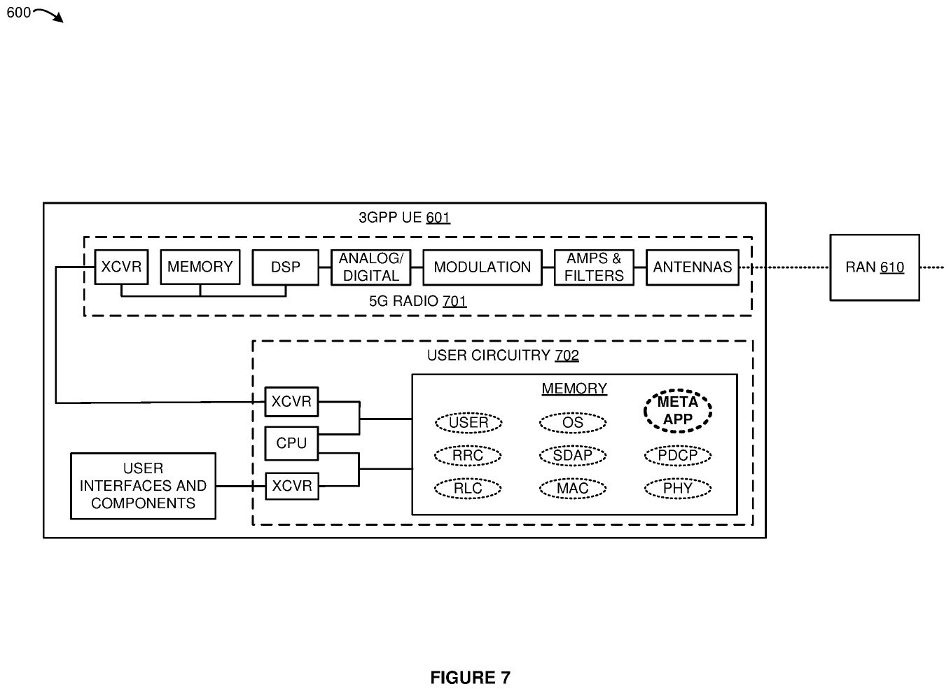

FIG. 7 illustrates 5G UE 601 in 5G communication network 600. UE 601 comprises an example of user device 101 and UE 301, although UEs 101 and 301 may differ. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER), metaverse application (META APP) and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). Metaverse application functions include metaverse services for augmented reality, virtual reality, voice/video conferencing, online gaming, social media, and the like.

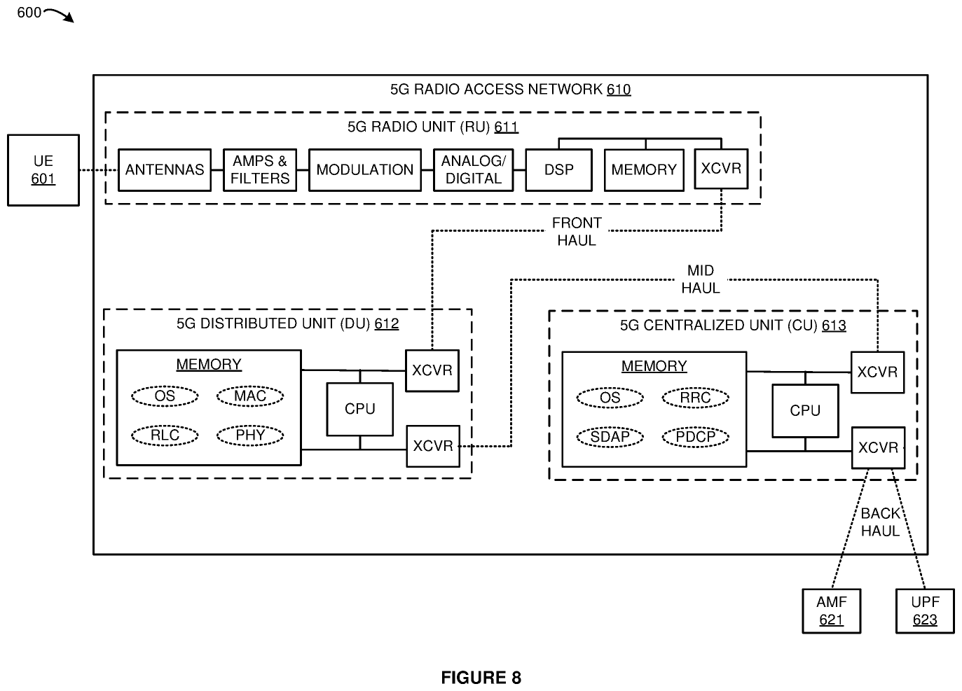

FIG. 8 illustrates 5G RU 611, 5G DU 612, and 5G CU 613 in 5G communication network 600. RU 611, DU 612, and CU 613 comprise an example of the access node 111 and RAN 311, although access node 111 and RAN 311 may differ. RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC, and RLC. CU 613 comprises memory, CPU, and transceivers that are coupled over bus circuitry. The memory in CU 613 stores an operating system and 5GNR network applications like PDCP, SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 620 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

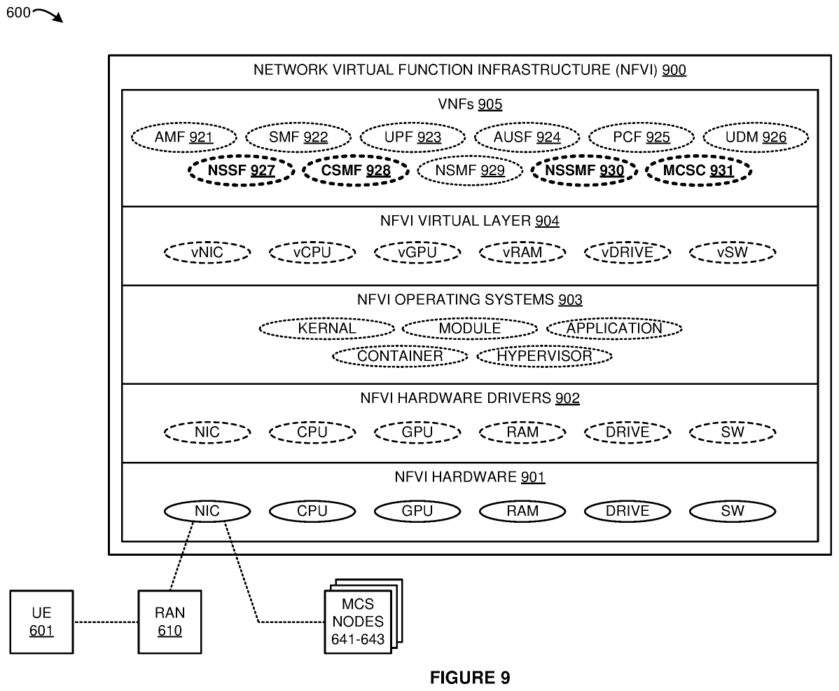

FIG. 9 illustrates Network Function Virtualization Infrastructure (NFVI) 900. NFVI 900 comprises an example of core network 121 illustrated in FIG. 1 and network slice 320, slice manager 331, and metaverse orchestrator 332 illustrated in FIG. 3, although core network 121 and network slice 320, slice manager 331, and metaverse orchestrator 332 may differ. NFVI 900 comprises NFVI hardware 901, NFVI hardware drivers 902, NFVI operating systems 903, NFVI virtual layer 904, and NFVI Virtual Network Functions (VNFs) 905. NFVI hardware 901 comprises Network Interface Cards (NICs), CPU, GPU, RAM, Flash/Disk Drives (DRIVE), and Data Switches (SW). NFVI hardware drivers 902 comprise software that is resident in the NIC, CPU, GPU, RAM, DRIVE, and SW. NFVI operating systems 903 comprise kernels, modules, applications, containers, hypervisors, and the like. NFVI virtual layer 904 comprises vNIC, vCPU, vGPU, vRAM, vDRIVE, and vSW. NFVI VNFs 905 comprise AMF 921, SMF 922, UPF 923, AUSF 924, PCF 925, UDM 926, NSSF 927, CSMF 928, NSMF 929, NSSMF 930, and MCSC 931. Additional VNFs and network elements like Unified Data Registry (UDR) and Network Exposure Function (NEF) are typically present but are omitted for clarity. NFVI 900 may be located at a single site or be distributed across multiple geographic locations. The NIC in NFVI hardware 901 is coupled to RAN 610 and to MCS nodes 641-643. NFVI hardware 901 executes NFVI hardware drivers 902, NFVI operating systems 903, NFVI virtual layer 904, and NFVI VNFs 905 to form AMF 621, SMF 622, UPF 623, AUSF 624, PCF 625, UDM 626, NSSF 627, CSMF 628, NSMF 629, NSSMF 630, and MCSC 631.

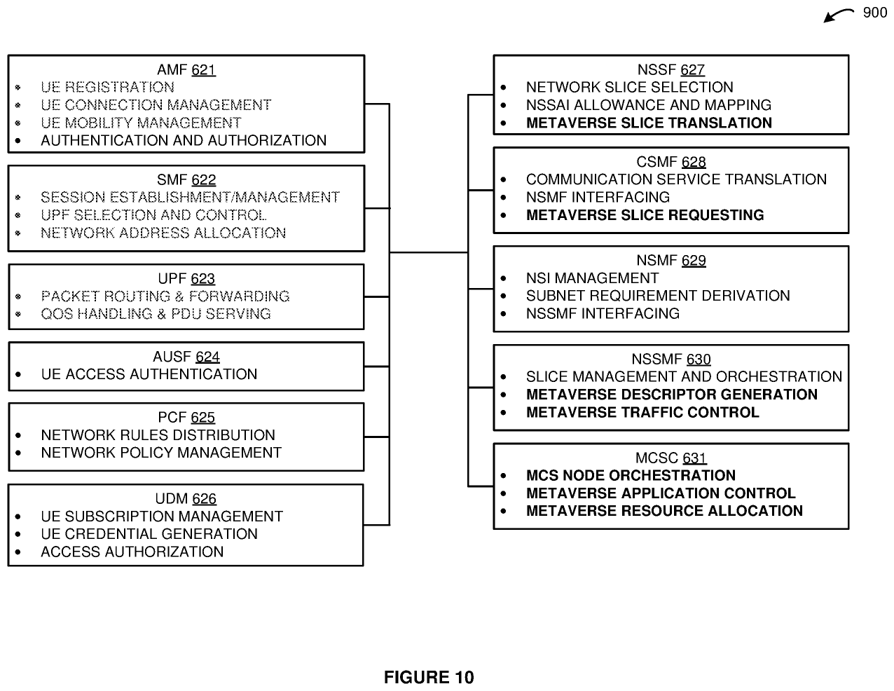

FIG. 10 further illustrates NFVI 900 in 5G communication network 600. AMF 621 performs UE access registration, UE connection management, UE mobility management, and UE authentication and authorization. SMF 622 performs session establishment and management, UPF selection and control, and network address allocation. UPF 623 performs packet routing and forwarding and QoS handling and PDU serving. AUSF 624 performs UE access authentication. PCF 625 performs network rules distribution and network policy management. UDM 626 performs UE subscription management, UE credential generation, and UE access authorization. NSSF 627 performs network slice selection, Network Slice Selection Assistance Information (NSSAI) allowance and mapping, and metaverse slice translation. CSMF 628 performs communication service translation, NSMF interfacing, and metaverse slice requesting. NSMF 629 performs Network Slice Instance (NSI) management, subnet requirement derivation, and NSSMF interfacing. NSSMF 630 performs slice management and orchestration, metaverse service descriptor generation, and metaverse traffic control. MCSC 631 performs MCS node orchestration, metaverse application control, and metaverse resource allocation.

In operation, AMF 621 receives a registration request for UE 601 from RAN 610. The registration request comprises information like a registration type, UE capabilities, requested slice types, and PDU session requests. AMF 621 transfers an identify request to UE 601 via RAN 610 and UE 601 responsively indicates its identity to AMF 621 via RAN 610. AMF 621 interacts with AUSF 624, UDM 626, and typically other network functions to authenticate and authorize UE 601 for wireless data services. Responsive to the authentication and authorization, AMF 621 retrieves UE context for UE 601 from UDM 626. UDM 626 access a subscriber profile for UE 601 and transfers UE context comprising QoS metrics, slice identifiers, network addresses, and the like. AMF 621 retrieves service policies for UE 601 from PCF 625. AMF 621 selects SMF 622 to establish a PDU session for UE 601 based on the UE context and the service policies. SMF 622 selects UPF 623 to establish the PDU session for UE 601. SMF 622 transfers session context for the PDU session to AMF 621. AMF 621 transfers the session context to UE 601 over RAN 610. UPF 623 exchanges user data for the PDU session with UE 601 over RAN 610.

AMF 621 receives a metaverse service request from UE 601 over RAN 610 and indicates the request to CSMF 628 to select an adequate network slice to handle the metaverse session. CSMF 628 receives the indication and transfers a network slice request to NSSF 627. NSSF 627 generates a network slice template based on the request and forwards the template to NSSMF 630. NSSMF 630 receives the network slice template and generates a metaverse service descriptor based on the template. The metaverse service descriptor comprises metaverse application requirements to support the requested metaverse session including information like application type, traffic type, latency requirements, bandwidth requirements, geographic location, and/or other types of service descriptors. NSSMF 630 transfers the metaverse service descriptor to MCSC 631.

MCSC 631 receives status reports from MCSs 644-646. The status reports comprise capacity and usage statistics for MCSs 644-646 like memory percent occupancy, processor load, number of active metaverse applications, number of active users, application usage, number of additional applications that can be hosted, number of additional users that can be served, server GPS coordinates, and/or other types of KPIs characterizing hardware/software usage and capacity. MCSC 631 maintains a data structure to track the hardware usage, hardware capacity, software usage, software capacity, and geographic locations for MCSs 644-646. MCSC 631 stores the hardware usage, hardware capacity, software usage, software capacity, and geographic locations in association with server ID and server network address. MCSC 631 directs MCSs 644-646 to deactivate the underused applications to free up hardware capacity when software usage falls below a threshold value. MCSC 631 redirects users that were served by the deactivated application to another suitable metaverse application to efficiently allocate and conserve computing resources. MCSC 631 directs the MCSs 644-646 to activate additional metaverse applications to provide metaverse services to additional users when software usage exceeds a threshold value for MCSs 644-646. MCSC 631 load balances metaverse service requests between MCSs 644-646 based on the data structure to preserve computing resources in the servers while maintaining the service requirements (e.g., latency, bandwidth, etc.) of the metaverse sessions.

In response to the metaverse service descriptor, MCSC 631 identifies ones of MCSs 644-646 that comprise software and/or hardware capacity to deploy an application based on the metaverse service descriptor. For example, MCSC 631 may identify the requirements of the requested session based on the service descriptor and access the data structure to determine ones of MCSs 644-646 that comprise adequate computing resources (e.g., CPU load, RAM percent occupancy, etc.) to support the session. MCSC 631 selects one of the identified servers to deploy the metaverse service descriptor based on its proximity to UE 601 to support the latency and service requirements of metaverse service descriptor. In some examples, MCSC 631 calculates a weighted score to select one of MCSs 644-646. The weighted score inputs may comprise geographic proximity, active metaverse application types, and server capacity. The following formula comprises an exemplary weighted score:

$$Score = ( \frac{A}{N} \times P ) + ( \frac{B}{N} \times M ) + ( \frac{C}{N} \times S )$$

where A, B, and C comprise the weights, P comprises the server geographic proximity, M comprises the active metaverse application, S comprise server capacity, and N comprises the normalizing factor. It should be appreciated that the above formula is exemplary and other scoring metrics could be used. The weights allow MCSC 631 to emphasize certain inputs over others. For example, if the metaverse service descriptor comprises ultra-low latency requirements, the proximity input may be weighted higher than the other inputs. MCSC 631 compares the scores for different ones of MCSs 644-646 and selects one of MCSs 644-646 based on its weighted score. It should be appreciated that other types of selection criteria may be used.

Upon selection of an MCS, MCSC 631 directs the selected MCS to deploy the metaverse application that corresponds to the metaverse service descriptor. In some examples, the metaverse application that corresponds to the metaverse service descriptor may already be deployed and MCSC 631 may direct the selected MCS to reserve space for UE 601. MCSC 631 relays server information to set up the end-to-end connection to NSMF 629 and NSSF 627. MCSC 631 maintains a list of network slice types to support various metaverse service descriptors. MCSC 631 informs NSSF 627 of the required slice type comprises a uRLLC slice to support the metaverse session. NSSF 627 selects a network slice comprising AMF 621, SMF 622, UPF 623, and the deployed metaverse application. In this example AMF 621 comprises a common AMF, SMF 622 comprises a uRLLC SMF, and UPF 623 comprises a uRLLC UPF.

In response to the network slice selection, NSMF 629 controls NSSMF 630 to organize the slice subnets to create an end-to-end connection between UE 601 and the deployed metaverse application. NSSMF 630 interacts with AMF 621 to isolate and forward metaverse traffic to desired network destinations. NSSMF 630 organizes the network slice subnets to build the end-to-end metaverse slice selected by NSSF 627. NSSMF 630 transfers the session context information for the metaverse session to AMF 621. AMF 621 directs SMF 622 to support the metaverse session and transfers the session context to SMF 622. SMF 622 receives the direction and controls UPF 623 to serve the metaverse session. UPF 623 exchanges user data for the metaverse session with UE 601 via RAN 610. UPF 623 exchanges the user data for the session with the metaverse application deployed in the selected MCS.

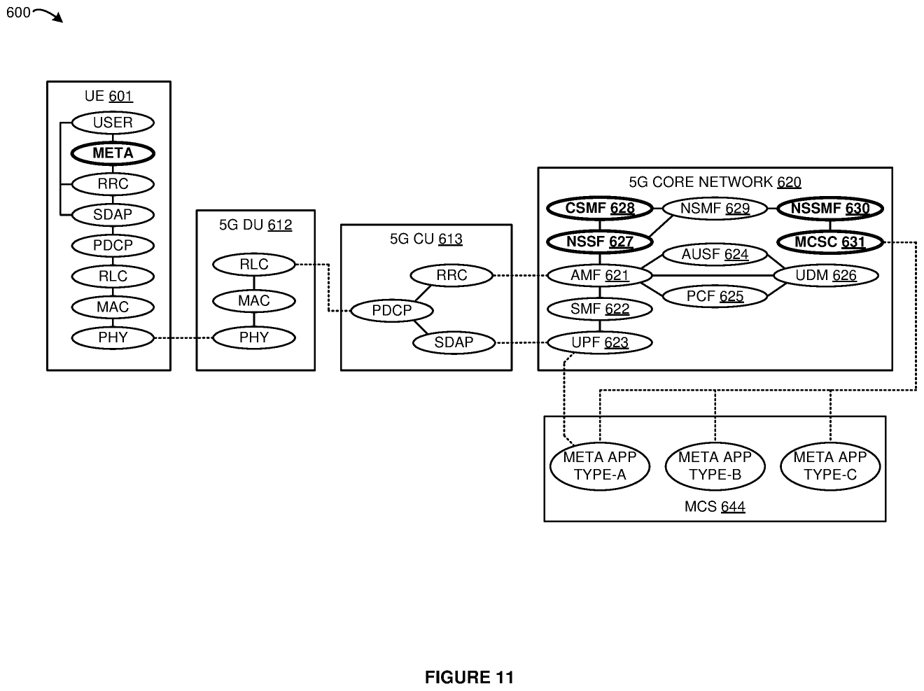

FIG. 11 illustrates an exemplary operation of 5G communication network 600 to orchestrate metaverse services for UE 601. The operation may vary in other examples. In operation, UE 601 wirelessly attaches to CU 613 via DU 612 and RU 611. The RRC in UE 601 transfers attachment signaling to CU 613 over the SDAPs, PDCPs, RLCs, MACs, and PHYS. The RRC in CU 613 receives the attachement signaling and establishes an RRC connection with the RRC in UE 601. The attachment signaling indicates the registration type, UE capabilities, requested slice types, and PDU session requests for UE 601. The RRC in CU 613 transfers a registration request for UE 601 to AMF 621. AMF 621 transfers an identify request for UE 601 to the RRC in CU 613. The RRC in CU 613 forwards the identify request to the RRC in UE 601 over the SDAPs, PDCPs, RLCs, MACs, and PHYs. The RRC in UE 601 indicates the UE identity to the RRC in CU 613 over the SDAPs, PDCPs, RLCs, MACs, and PHYs. The RRC in CU 613 forwards the UE identity to AMF 621. AMF 621 interacts with AUSF 624 and UDM 626 to authenticate and authorize UE 601 for wireless data services.

Responsive to the authentication and authorization, AMF 621 requests UE context for UE 601 from UDM 626. UDM 626 accesses the subscriber profile of UE 601 and transfers the UE context for UE 601 to AMF 621. AMF 621 retrieves service policies for UE 601 from PCF 625. AMF 621 directs SMF 622 to establish a PDU session for UE 601 based on the UE context and the service policies. SMF 622 selects UPF 623 to establish the PDU session for UE 601. SMF 622 transfers session context for the PDU session to AMF 621. AMF 621 transfers the session context to the RRC in CU 613. The RRC in CU 613 forwards the session context to the RRC in UE 601 over the SDAPs, PDCPs, RLCs, MACs, and PHYs. The RRC in UE 601 directs the SDAP in UE 601 to begin the PDU session based on the session context. The SDAP in UE 601 exchanges user data with the SDAP in CU 613 over the PDCPs, RLCs, MACs, and PHYs. The SDAP in CU 613 exchanges the user data with UPF 623.

In response to user input, UE 601 executes the metaverse application (META). In response to the metaverse application execution, the RRC in UE 601 transfers a corresponding service request to the RRC in CU 613 over the SDAPs, PDCPs, RLCs, MACs, and PHYs. In this example, the metaverse application comprises a metaverse online gaming application. The RRC in CU 613 receives the metaverse service request and forwards the request to AMF 621. AMF 621 detects the metaverse service request and indicates the request to CSMF 628 to set up an adequate network slice to handle the requested metaverse session type. CSMF 628 determines the metaverse request comprises a request for a metaverse online gaming session. CSMF 628 determines bandwidth requirements for the metaverse gaming session and transfers a slice request for a network slice to support the metaverse online gaming session to NSSF 627. NSSF 627 generates a network slice template based on the request and transfers the template to NSSMF 630. The slice template indicates the session type and the bandwidth requirements. NSSMF 630 receives the network slice template and generates a metaverse service descriptor based on the template. The metaverse service descriptor comprises metaverse application requirements to support the requested metaverse session including application type, traffic type, latency requirements, bandwidth requirements, geographic location, and/or other types of service descriptors. NSSMF 630 transfers the metaverse service descriptor to MCSC 631.

MCS 644 hosts metaverse applications type-A, type-B, and type-C to provide metaverse services for user devices like virtual voice/video conferencing, virtual spaces, online gaming, and/or other types of metaverse services. In this example, metaverse application type-A comprises a metaverse online gaming application. MCSs 644-646 track their hardware usage, hardware capacity, software usage, software capacity, and geographic locations. MCSs 644-646 generate and transfer status reports that include their hardware usage, hardware capacity, software usage, software capacity, and geographic locations to MCSC 631. MCSC 631 maintains a data structure based on the status reports. The data structure tracks KPIs for MCSs 644-646 comprising memory percent occupancy, processor load, number of active metaverse applications, number of active users, application usage, number of additional applications that can be hosted, number of additional users that can be served, and server GPS coordinates. The data structure stores the KPIs for MCSs 644-646 in association with server ID and server network address for MCSs 644-646.

MCSC 631 identifies ones of MCSs 644-646 that comprise software and/or hardware capacity to deploy an application to associated with the metaverse service descriptor based on the data structure. MCSC 631 selects MCS 644 based on its proximity to UE 601, its capacity, and its available application types to serve the metaverse online gaming session for UE 601. Since the metaverse application type-A is currently deployed and comprises the metaverse online gaming service requested by UE 601, MCSC 631 directs MCS 644 to reserve hardware and software resources for UE 601. MCSC 631 transfers network addresses for MCS 644 to NSMF 629 and NSSF 627. MCSC 631 informs NSSF 627 the required slice type comprises an emBB slice. NSSF 627 selects a corresponding emBB network slice comprising AMF 621, SMF 622, UPF 623, and metaverse application type-A. In this example, AMF 621 comprises a common AMF, SMF 622 comprises an emBB SMF, and UPF 623 comprises an emBB UPF.

In response to the network slice selection, NSMF 629 controls NSSMF 630 to organize the slice subnets to exchange metaverse data between UE 601 and metaverse application type-A. NSSMF 630 interacts with AMF 621 to isolate and forward metaverse traffic to various network destinations. NSSMF 630 organizes the network slice subnets to build the end-to-end metaverse slice selected by NSSF 627. NSSMF 630 transfers session context information and network slice information (e.g., core network addresses) for the metaverse session to AMF 621. AMF 621 directs SMF 622 to support the metaverse session and transfers session context to SMF 622. SMF 622 receives the direction and controls UPF 623 to serve the metaverse online gaming session. AMF 621 transfers the session context information to the RRC in CU 613. The RRC in CU 613 transfers the session context information to the RRC in UE 601 over the SDAPs, PDCPs, RLCs, MACs, and PHYs. The RRC in UE 601 directs the metaverse application and SDAP in UE 601 to begin the online gaming session using the session context information. The SDAP in UE 601 exchanges user data generated by the metaverse application in UE 601 with the SDAP in CU 613 over the SDAPs, PDCPs, RLCs, MACs, and PHYs. The SDAP in CU 613 exchanges the user data with UPF 623. UPF 623 exchanges the user data with the metaverse application type-A in MCS 644.

The wireless data network circuitry described above comprises computer hardware and software that form special-purpose network circuitry to orchestrate metaverse services for wireless user devices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to orchestrate metaverse services for wireless user devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless communication network to orchestrate metaverse services for wireless user devices, the method comprising:
receiving and processing a metaverse service request from a wireless user device that indicates a device location and a metaverse type;
selecting a network slice to serve a metaverse session based on the metaverse type indicated by the metaverse service request;
identifying application servers that provide metaverse services that have sufficient capacity to serve the metaverse session; and
selecting a server of the identified application servers based on a proximity between the device location and a geographic location of the server.

2. The method of claim 1 further comprising:
directing the server to deploy a metaverse application for the metaverse session;
exchanging user data for the metaverse session with the wireless user device over the network slice; and
exchanging the user data for the metaverse session with the server.

3. The method of claim 1 further comprising:
receiving and processing an additional metaverse service request;
determining the network slice is at capacity; and
instantiating another network slice to serve an additional metaverse session based on the additional metaverse service request.

4. The method of claim 1 further comprising:
determining the application servers are at capacity; and
in response, transferring instructions to activate an additional application server that provides metaverse services.

5. The method of claim 1 further comprising:
determining one or more of the application servers are redundant; and
in response, transferring instructions to deactivate the one or more redundant application servers.

6. The method of claim 1 further comprising:
receiving and processing an additional metaverse service request from an additional wireless user device;
determining the additional metaverse service request is associated with the metaverse service request received from the wireless user device; and
selecting the network slice to serve an additional metaverse session for the additional wireless user device based on the association.

7. The method of claim 1 further comprising:
monitoring capacities for the application servers by receiving status reports from each of the application servers.

8. The method of claim 1 wherein selecting the network slice comprises selecting an Enhanced Mobile Broadband (eMBB) network slice comprising an Access and Mobility Management Function (AMF), an eMBB Session Management Function (SMF), and an eMBB User Plane Function (UPF).

9. The method of claim 1 wherein selecting the network slice comprises selecting an Ultra-Reliable Low-Latency Communication (uRLLC) network slice comprising an Access and Mobility Management Function (AMF), a uRLLC Session Management Function (SMF), and a uRLLC User Plane Function (UPF).

10. A wireless communication network configured to orchestrate metaverse services for wireless user devices, the wireless communication network comprising:
a metaverse orchestrator configured to:
receive and process a metaverse service request from a wireless user device that indicates a device location and a metaverse type;
identify application servers that provide metaverse services that have sufficient capacity to serve a metaverse session; and
select a server of the identified application servers based on a proximity between the device location and a geographic location of the server; and
a network slice manager configured to:
select a network slice to serve the metaverse session based on the metaverse type indicated by the metaverse service request.

11. The wireless communication network of claim 10 wherein:
the metaverse orchestrator is further configured to:
direct the server to deploy a metaverse application for the metaverse session; and
the network slice is configured to:
exchange user data for the metaverse session with the wireless user device; and
exchange the user data for the metaverse session with the server.

12. The wireless communication network of claim 11 wherein the network slice comprises an Access and Mobility Management Function (AMF), an Enhanced Mobile Broadband (eMBB) Session Management Function (SMF), and an eMBB User Plane Function (UPF).

13. The wireless communication network of claim 11 wherein the network slice comprises an Access and Mobility Management Function (AMF), an Ultra-Reliable Low-Latency Communications (uRLLC) Session Management Function (SMF), and a uRLLC User Plane Function (UPF).

14. The wireless communication network of claim 11 wherein the network slice comprises an Access and Mobility Management Function (AMF), a Massive Machine-Type Communications (mMTC) Session Management Function (SMF), and an mMTC User Plane Function (UPF).

15. The wireless communication network of claim 10 wherein the metaverse orchestrator comprises a Metaverse Client Server Controller (MCSC).

16. The wireless communication network of claim 10 wherein the network slice manager comprises a Communication Service Management Function (CSMF), a Network Slice Selection Function (NSSF), and a Network Slice Subnet Management Function (NSSMF).

17. The wireless communication network of claim 10 wherein the metaverse orchestrator is configured to receive status reports from each of the application servers that indicate individual capacity for each of the application servers.

18. A method of operating a wireless communication network to orchestrate metaverse services for wireless user devices, the method comprising:
monitoring geographic locations and capacities for application servers that provide metaverse services;
receiving and processing a metaverse service request from a wireless user device that indicates a device location and a metaverse type;
selecting a network slice to serve a metaverse session based on the metaverse type indicated by the metaverse service request;
identifying ones of the application servers that have sufficient capacity to serve the metaverse session;
selecting a server of the identified ones of the application servers based on a proximity between the device location and a geographic location of the server;
directing the server to deploy a metaverse application for the metaverse session;
exchanging user data for the metaverse session with the wireless user device over the network slice; and
exchanging the user data for the metaverse session with the server.

19. The method of claim 18 further comprising:
receiving and processing an additional metaverse service request;
determining the network slice is at capacity; and
instantiating another network slice to serve an additional metaverse session based on the additional metaverse service request.

20. The method of claim 18 further comprising:
determining the application servers are at capacity based on the monitoring;
in response, transferring instructions to activate an additional application server; and
load balancing additional metaverse service requests between the application servers.
